(19) United States
(12) Patent Application Publication
(10) Pub. No.: US 2006/0117839 A1
(43) Pub. Date: Jun. 8, 2006

(54) Microdebris monitor

(75) Inventors: Jeffrey Bernard Fortin, Niskayuna, NY (US); Todd Garrett Wetzel, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/001,851

(22) Filed: Dec. 2, 2004

(51) Int. Cl. G01N 11/00

(52) U.S. Cl. 73/61.73

(57) ABSTRACT

An apparatus and method are provided for monitoring wear of a component disposed within a fluid stream. The apparatus comprises at least one particle trap configured to capture particles from a fluid stream. The trap comprises a trapping medium having a minimum orifice size. The apparatus further comprises at least one sampler configured to divert at least a portion of the fluid stream through the trapping medium; and at least one sensor system configured to determine at least one flow characteristic in the apparatus. The method comprises flowing fluid from the stream through the apparatus described above, and determining the extent of wear in the component based on flow characteristic data obtained from the sensor system of the apparatus.

### BACKGROUND OF THE INVENTION

This invention relates to apparatus and methods for monitoring machine components. More particularly, this invention relates to apparatus and methods to capture and analyze wear debris emanating from machine components during service. This invention also relates to control systems that use such apparatus and methods.

Wear is the removal of material from a surface by frictional forces acting on that surface. Machine components that are subject to contact in relative motion with other components, such as, for example, roller bearings in rotating machinery, are subject to degradation over time due to wear. The gradual removal of material from a bearing by the wear process degrades its performance over time until eventually the bearing can no longer properly support the stresses it was originally designed to support. As the sudden failure of a bearing or other component during service can result in costly damage to other machine components, there is considerable interest in monitoring the status of components in service to determine the point at which they should be replaced, thereby reducing the risk of a catastrophic failure due to wear.

In many bearing applications, a stream of lubricant is flowed over the bearings to reduce wear and prolong bearing life. Despite the presence of a lubricant, however, bearings continue to wear during service, and as this occurs particles of the bearing metal generally on the order of 10 micrometers through 1000 micrometers in size break off of the bearing surface and are entrained in the flow of lubricant. This debris is typically caught by a filter at some point in the lubrication system. The number of particles discharged from thee surface tends to increase as the bearing nears the end of its useful life.

A number of technologies are currently used to monitor wear of components disposed within a flowing fluid stream. These techniques all monitor in one way or another the particles that are emitted by a component as it degrades. Some techniques involve collection of particles for off-line analysis, using a magnet, filter, or other collection means. Other techniques employ electrostatic techniques to count particles as they flow past a certain point in the lubrication system. These currently available techniques typically suffer from one or more disadvantages, in that many of them do not allow for real-time analysis or do not have sufficient resolution to detect very small particles in the size range of 200 micrometers or less.

Therefore, there is a need to provide cost effective, high-resolution devices and methods for real-time monitoring of bearings and other machine components subject to wear during service.

### BRIEF DESCRIPTION

Embodiments of the present invention address these and other needs. One embodiment is an apparatus for monitoring wear of component disposed within a fluid stream. The apparatus comprises at least one particle trap configured to capture particles from a fluid stream. The trap comprises a trapping medium having a minimum orifice size. The apparatus further comprises at lease one sampler configured to divert at least a portion of the fluid stream through the trapping medium; and at lease one sensor system configured to determine at lease one flow characteristic in the apparatus. Another embodiment is a method for monitoring wear of a component disposed within a fluid stream. The method comprises flowing fluid from the stream through the apparatus described above, and determining the extent of wear in the component based on flow characteristic data obtained from the sensor system of the apparatus.

### BRIEF DESCRIPTION OF THE DRAWINGS

These and other features, aspects, and advantages of the present invention will become better understood when the following detailed description is read with reference to the accompanying drawings in which like characters represents like parts throughout the drawings, wherein:

FIGS. 1, 2 and 3 are schematic cross-sections of various embodiments of the apparatus of the present invention.

### DETAILED DESCRIPTION

Disclosed herein are apparatus and methods for monitoring wear of a component disposed within a fluid stream; examples of each components include various types of bearings, gears, and any other component subjected to frictional forces while disposed in a stream of fluid. The ability to monitor the wear of components as provided by embodiments described herein allows an operator of a machine to be alerted when components become excessively worn and to replace such components prior to the occurrence of a catastrophic failure. The apparatus and methods of the present invention are flexible and robust, and allow for instantaneous measurement without the need to interrupt the operation of the machine or the apparatus to perform the measurement.

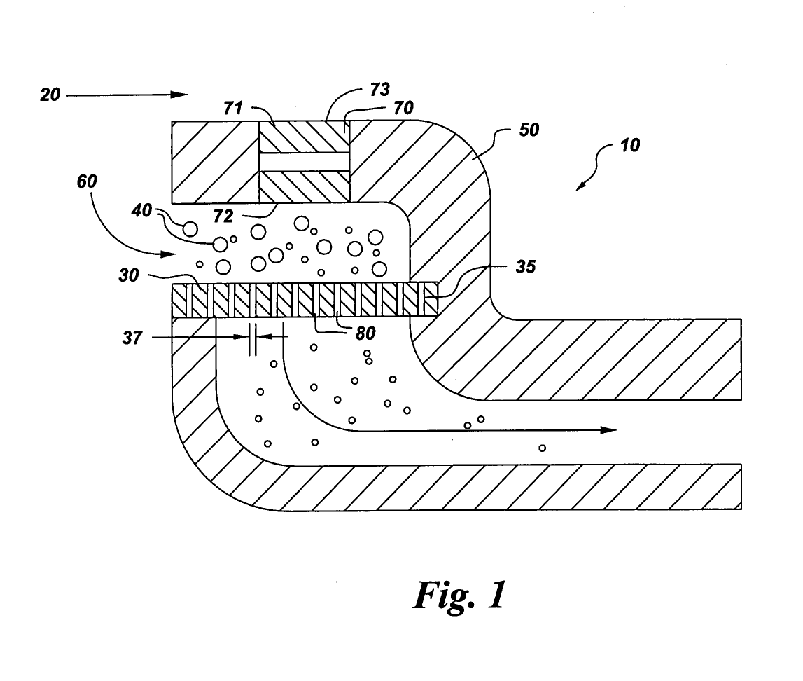

Referring to FIG. 1, an exemplary embodiment of an apparatus 10 for monitoring wear of a component disposed within a fluid steam 20 comprises at lease one particle trap 30, at least one sampler 50, and at least one sensor system 70. Fluid stream 20, in certain embodiments, comprises a lubricant, such as an oil, for instance. Particle trap 30 comprises a trapping medium 35 having a minimum orifice size 37. At least a portion 60 of stream 20 is diverted through trapping medium 35 by sampler 50, and sensor system 70 determines at least one flow characteristic in apparatus 10. As will be explained below, this flow characteristic is generally related to the number of particles 40 that are caught in trap 30, which in turn relates to the amount of wear that has occurred in components upstream of apparatus 10. This flow characteristic thus can be reported to an operator as a measure of the status of these upstream components.

Particle trap 30 is configured to capture particles 40 from a fluid stream 20 through the use of trapping medium 35. Trapping medium 35 comprises orifices 80 that allow fluid to flow through while trapping particles 40 entrained in the fluid if the particles 40 are too large to move through the orifices 80. The minimum size of the orifices 80 can be selected to capture particles 40 having a particular size in a predetermined range. Particles larger than the minimum orifice size 37 will be unable to move through the trapping medium. Therefore, the selection of a particular minimum orifice size 37 determines the minimum size of the particles 40 that will be trapped by the trapping medium 35. In some embodiments the minimum orifice size 37 is up to about 500 micrometers. In certain embodiments the minimum orifice size is up to about 10 micrometers, and in particular embodiments the minimum orifice size is up to about 10 micrometers. Trapping medium 25, in some embodiments, is fabricated from any suitable filter material, including as examples glass wool, paper, sand, activated carbon, polymers, and other porous materials. Aluminum oxide filters, fabricated by anodization methods to produce structures having small, tightly controlled pore sizes, are also suitable for use in embodiments of the present invention. In particular embodiments, trapping medium 35 comprises silicon. Silicon wafers can be micro-machined using standard semiconductor etching techniques to fabricate filters having precisely controlled channel inner diameters down to about 1 micrometer. Such structures are well-suited to use in embodiments of the present invention because they are capable of trapping very fine particles and particles of a tightly controlled particle size range.

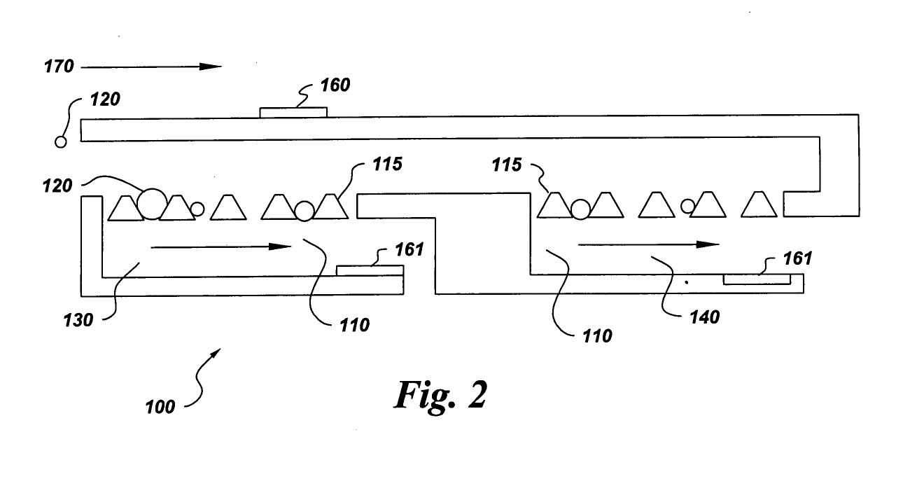

The ability to fabricate a trap 30 configures to capture particles 40 having a particle size in a predetermined range advantageously provides the apparatus of the present invention with the capability to sort particles 40 by their sizes and to determine which particle size range predominates among the particles 40 entrained in the fluid stream 20. This information may be helpful in determining how close upstream components are to catastrophic failure. Referring to FIG. 2, sorting of particles by size is achieved in certain embodiments where apparatus 100 comprises a plurality is configured to capture particles 120 having a particle size in a predetermined range, and the range is different for each trap 110. That is, each trap 110 of the plurality comprises a trapping medium 115 having a unique minimum orifice size. For example, a first trap 130 is configured to trap only very large particles (large minimum orifice size), allowing smaller particles to pass through, while a second trap 140 is configured to trap fine particles (smaller minimum orifice size).

Sampler 50 (FIG. 1) is configured to divert at least a portion of fluid stream 20 through trapping medium 35. The figure shows a generally scoop-shaped configuration, but it will be appreciated that other configurations for sample 50 are suitable to divert a portion of fluid stream 20 into trap 30. In some embodiments, sampler 50 is configured to divert a sufficiently small portion of fluid stream 20 such that the flow of steam 20 is not restricted to an unacceptable level by pressure drop effects. In certain embodiments, sampler is configured to divert up to about 5% by volume, and in particular embodiments up to 2% by volume, of fluid stream 20.

Sensor system 70 is configured to determine at least one flow characteristic in trap 30. Any flow characteristic selected for use in apparatus 10 is desirably related to the number of particles 40 caught in trap 30. Examples of suitable characteristics include pressure, flow rate, and flow force. In general, as trapping medium 35 becomes filled with trapped particles, flow through trap 30 is impeded, causing a change in certain flow characteristics. For example, the velocity and flow rate are reduced as trap 30 becomes blocked by trapped particles. The fluid pressure inside apparatus 10 and upstream of trapping medium 35 increases as medium 35 becomes loaded with trapped particles.

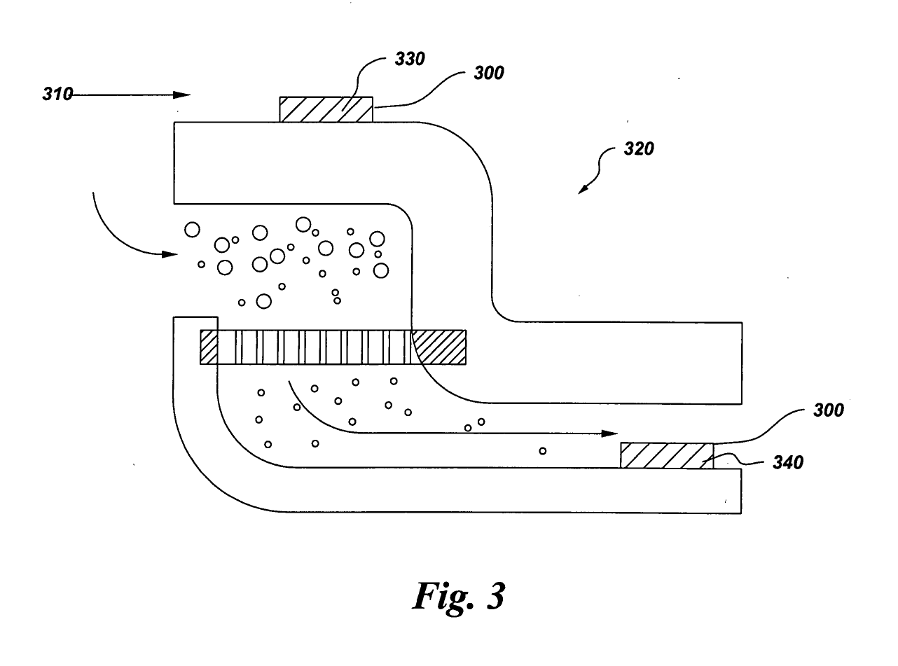

Sensor system 70, in some embodiments, is configured to measure pressure, wherein the pressure measured is wall pressure, fluid pressure, or a combination of these. In certain embodiments, as illustrated in FIG. 1, sensor system 70 comprises a differential pressure sensor 71. This type of sensor generally comprises one unit having two sensing surfaces, wherein a first sensing surface 72 is exposed to fluid within apparatus 10 and a second sensing surface 73 is exposed to fluid in the main fluid stream 20. The differential pressure sensor 71 measures the difference between the pressures at the two sensing surfaces. Various types of differential pressure sensor are suitable for use in embodiments of the present invention, including micro-electro-mechanical sensors (MEMS) known to those in the art. In an alternative to the use of a differential pressure sensor 71, as illustrated in FIG. 3, sensing system 300 comprises a first pressure sensor 330 disposed in the fluid stream 310 outside of apparatus 320 and a second pressure sensor 340 disposed inside apparatus 320. In particular embodiments, sensing system 300 further comprises a comparator (not shown) configured to receive and compare data from first pressure sensor 330 and second pressure sensor 340. In this way the pressure differential between fluid in apparatus 320 and in the main fluid stream 310 can be compared.

Sensor system 70, in other embodiments, is configured to measure flow rate, wherein the flow rate measured is volumetric flow rate, mass flow rate, velocity of flow, or a combination of these. Sensors suitable for use in embodiments of this type include MEMS flow rate sensors and anemometers. In some embodiments, one flow rate sensor is disposed inside apparatus 10 to measure the absolute value of the flow rate within apparatus 10. In other embodiments, an additional flow rate sensor is disposed outside apparatus 10 to provide information about the difference between flow rates internal and external to the apparatus. In particular embodiments, apparatus 10 further comprises a comparator (not shown) configured to receive and compare data from each of the sensors disposed internal and external to apparatus 10.

The sensor system, in other in other embodiments, is configured to measure the force of the flow acting on the apparatus. In certain embodiments, sensor system comprises at least one strain gauge sensor disposed on the trap. Various suitable strain gauges are commercially available. The strain gauge sensor measures strain in the apparatus resulting from the application of force on the trap by fluid as it flows through the trap. The strain in the trap is directly proportional to the force applied by the fluid, which increases as the trap becomes blocked with trapped particles.

As shown in FIG. 2 and described above, certain embodiments of the present invention include the case where apparatus 100 comprises a plurality of traps 110, each designed to trap particles of a different size range from the other traps. In some of these embodiments, sensor system comprises a plurality of trap sensors 160 disposed to measure a flow characteristic immediately downstream of each trap 110 of the apparatus 100. In this way, data from each trap sensor can be compared to determine the relative population fractions for each desired size range. For instance, if a flow rate measured immediately downstream of a trap designed to capture a coarse particle size range decreases during operation much more quickly than a flow rate measured immediately downstream of a trap designed to capture a finer particle size range, then the data would suggest that the population of particles entrained in the fluid stream is dominated by coarse particles. In particular embodiments, sensor system further comprises at least one main stream sensor 161, disposed to sense a flow characteristic of the main fluid stream 170, in order to allow for comparative analysis of the flow characteristic measured downstream of each trap relative to that measured for the main fluid stream 170.

Data generated by sensor system 70 can be sent to a monitoring device via an output module for eventual viewing by an operator, or to a data storage device. In addition or instead, data generated by sensor system 70 can be sent via an output module to a controller. Various types of output modules suitable for receiving data from a sensor and transmitting to a receptor, such as a controller or a monitoring device, are known in the art and are suitable for use in such embodiments. In particular applications, apparatus 10 is a component of a closed loop control system. In such cases, data from sensor system 70 is sent to a controller (not shown) whereupon the controller acts upon the data to manipulate certain operating conditions of the machine containing apparatus 10 in response to the data. For example, the controller may be programmed to stop the system and notify an operator that a component requires replacement.

In the method of the present invention, fluid from fluid stream 20 is flowed through apparatus 10 described above. The extent of wear in a component upstream of apparatus 10 is determined based on the flow characteristic data obtained from sensor system 70. For example, it may be known that a particular component begins to emit particles above 700 micrometers in size only as it begins to reach its failure point. Thus a trap designed to capture particles of 700 micrometers and above would begin to show changes in a flow characteristic—a reduction in flow rate, for instance—measured by the sensor system as the component nears the end of its useful life. Based on this flow characteristic data, and the correlation between particle size and component life expectancy described above, the extent of wear in the component would be determined to be close to the component failure point.

In certain embodiments, determining the extent of wear in the upstream component comprises continuously monitoring flow characteristic data from the sensor system. Continuous monitoring can be achieved, for example, by coupling the output module of the sensor system to a computer, chart recorder, gauge, or other appropriate data storage or monitoring device. In particular embodiments, the method further comprises sending a signal, from the output module of the sensor system, for example, where the signal is indicative of the determined extent of wear in a monitored upstream component. This signal can be sent within a closed loop control system to allow a controller to adjust operating parameters, as described above, or the signal can simply be sent to a data storage and monitoring device.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. An apparatus for monitoring wear of a component disposed within a fluid stream, said apparatus comprising:
at least one particle trap configured to capture particles from a fluid stream, said trap comprising a trapping medium having a minimum orifice size;
at least one sampler configured to divert at least a portion of said fluid stream through said trapping medium; and
at least one sensor system configured to determine at least one flow characteristic in said apparatus.

2. The apparatus of claim 1, wherein said flow characteristic comprises at least one characteristic selected from the group consisting of pressure, flow rate, and flow force.

3. The apparatus of claim 2, wherein said flow characteristic comprises pressure.

4. The apparatus of claim 3, wherein said sensor system comprises a differential pressure sensor.

5. The apparatus of claim 4, wherein said differential pressure sensor comprises a micro-electro-mechanical (MEMS) pressure differential pressure sensor.

6. The apparatus of claim 3, wherein said sensor system comprises a first pressure sensor disposed in said fluid stream outside of said at least one trap and a second pressure sensor disposed inside said at least one trap.

7. The apparatus of claim 6, further comprising a comparator configured to receive and compare data from said first pressure sensor and said second pressure sensor.

8. The apparatus of claim 2, wherein said flow characteristic comprises flow rate.

9. The apparatus of claim 8, wherein said sensor system comprises at least one sensor selected from the group consisting of an anemometer and a MEMS flow rate sensor.

10. The apparatus of claim 8, wherein said sensor system comprises a first flow rate sensor disposed in said fluid stream outside of said at least one trap and a second flow rate sensor disposed inside said at least one trap.

11. The apparatus of claim 6, further comprising a comparator configured to receive and compare data from said first flow rate sensor and said second flow rate sensor.

12. The apparatus of claim 2, wherein said flow characteristic comprises flow force.

13. The apparatus of claim 12, wherein said sensor measures strain in said at least one trap resulting from said flow force.

14. The apparatus of claim 1, wherein said minimum orifice size is up to about 500 micrometers.

15. The apparatus of claim 14, wherein said minimum orifice size is up to about 50 micrometers.

16. The apparatus of claim 15, wherein said minimum orifice size is up to about 10 micrometers.

17. The apparatus of claim 1, wherein said apparatus comprises a plurality of particle traps.

18. The apparatus of claim 17, wherein each trap of said plurality comprises a trapping medium having a unique minimum orifice size.

19. The apparatus of claim 18, wherein said sensor system comprises a plurality of trap sensors disposed to measure a flow characteristic immediately downstream of each trap.

20. The apparatus of claim 19, wherein said sensor system further comprises at least one main stream sensor disposed to sense a flow characteristic of said fluid stream.

21. The apparatus of claim 1, wherein said trapping medium comprises silicon.

22. The apparatus of claim 21, wherein said medium comprises a micromachined structure.

23. The apparatus of claim 1, wherein said trapping medium comprises at least one material selected from the group consisting of aluminum oxide, glass wool, paper, sand, activated carbon, polymers, and combinations of any of the foregoing.

24. The apparatus of claim 1, wherein said sampler is configured to divert up to about 5% by volume of said fluid stream.

25. The apparatus of claim 24, wherein said sampler is configured to divert up to about 2% by volume of said fluid stream.

26. The apparatus of claim 1, wherein said fluid stream comprises a lubricant.

27. The apparatus of claim 26, wherein said lubricant comprises an oil.

28. The apparatus of claim 1, wherein said apparatus further comprises an output module in communication with said sensor system.

29. The apparatus of claim 28, wherein said apparatus is a component of a closed-loop control system.

30. An apparatus for monitoring wear of a component disposed within a lubricant stream, said apparatus comprising:
at least one particle trap configured to capture particles from a fluid stream, said trap comprising a micromachined silicon trapping medium having a minimum orifice size of up to about 500 micrometers;
a flow sampler configured to divert up to about 5% by volume of said lubricant stream through said trapping medium; and
at least one sensor system configured to determine at least characteristic in said particle trap, said characteristic being selected from the group consisting of pressure, flow rate, and flow force.

31. A method for monitoring wear of a component disposed within a fluid stream, said method comprising:
flowing fluid from said stream through an apparatus comprising
at least one particle trap configured to capture particles from a fluid stream, said trap comprising a trapping medium having a minimum orifice size,
a flow sampler configured to divert at least a portion of said fluid stream through said trapping medium, and
at least one sensor system configured to determine a flow characteristic through said particle trap; and
determining the extent of wear in said component based on flow characteristic data obtained from said sensor system of said apparatus.

32. The method of claim 31, wherein determining comprises continuously monitoring said flow characteristic data.

33. The method of claim 31, wherein said flow characteristic comprises at least one characteristic selected from the group consisting of pressure, flow rate, and flow force.

34. The method of claim 31, wherein said sensor system comprises a first sensor disposed in said fluid stream outside of said at least one trap and a second sensor disposed inside said at least one trap.

35. The method of claim 34, wherein said apparatus further comprises a comparator configured to receive and compare data from said first sensor and said second sensor.

36. The method of claim 35, wherein said apparatus comprises a differential sensor.

37. The method of claim 31, wherein said apparatus comprises a plurality of particle traps.

38. The method of claim 37, wherein each trap of said plurality comprises a trapping medium having a unique minimum orifice size.

39. The method of claim 31, wherein said flow sampler is configured to divert up to about 5% by volume of said fluid stream.

40. The method of claim 31, wherein flowing said fluid comprises flowing a lubricant.

41. The method of claim 40, further comprising sending a signal indicative of the determined extent of wear in said component.

42. The method of claim 41, wherein sending said signal comprises sending said signal within a closed loop control system.

43. A method for monitoring wear of a component disposed within a lubricant stream, said method comprising:
flowing lubricant from said stream through an apparatus comprising
at least one particle trap configured to capture particles from a fluid stream, said trap comprising a micromachined silicon trapping medium having a minimum orifice size of up to about 500 micrometers;
a flow sampler configured to divert up to about 5% by volume of said lubricant stream through said trapping medium; and
at least one sensor system configured to determine at least one characteristic in said particle trap, said characteristic selected from the group consisting of pressure, flow rate, and flow force;
determining the extent of wear in said component based on flow characteristic data obtained from said sensor system of said apparatus; and
sending a signal indicative of the determined extent of wear in said component.
